(19) United States
(12) Patent Application Publication
(10) Pub. No.: US 2007/0040017 A1
(43) Pub. Date: Feb. 22, 2007

(54) Wireless biometric cardholder apparatus, method, & system

(76) Inventor: Douglas Kozlay, Timonium, MD (US)

Correspondence Address: DOUGLAS KOZLAY, SUITE 304, 9475 DEERECO RD., TIMONIUM, MD, 21093, US

(21) Appl. No.: 11/208,945

(22) Filed: Aug. 22, 2005

(51) Int. Cl. G06K 5/00; G06K 7/06

(52) U.S. Cl. 235/380; 235/441

(57) ABSTRACT

A wireless biometric cardholding apparatus is disclosed. The invention facilitates remote reading and writing smartcards after a user has been biometrically authenticated. The invention promotes secure, wireless exchange of data between standard smartcards and an application, via a remote external RF transceiver. This invention enables enrolled users to access physical, logical, or financial resources and/or other protected assets. The cardholding apparatus holds a conventional identifying card, badge, or smartcard. One preferred embodiment is constructed of clear plastic and/or is of sufficiently open design that it displays visible ID credentials. The invention actively reads identification data from the smartcard, cryptographically protects data, and transmits it by means of radio or other wireless communications to a reader terminal. The cardholding apparatus also contains a biometric authenticator that positively identifies the cardholder, and inhibits transmission until after successful authentication completion. The apparatus protects the cardholder from identity theft by preventing unauthorized tracking.

### BACKGROUND OF THE INVENTION

1. Field of the Invention

The field of the invention is personal identification badges and smartcards, and peripherals that improve their operation and ease of use. More particularly, the field of the invention is cardholding devices which display visual data for inspection, which read data and/or identity verification result data—and after a user fingerprint is authenticated—then wirelessly and securely exchange data between a card or badge inserted in the cardholding apparatus, and a selected application, via an external RF transceiver.

2. Related Art

The undersigned was unable to find any directly related art. Two US Design Patents—D475,708 and D426,237—show products that are indirectly, superficially comparable to the present invention; however, these aren't “wearable”, like a badgeholder; nor do these present and expose printed card or badge indicia for easy visual inspection; nor do they appear to offer the diverse utility of the present invention.

3. Necessity of the Invention

ID card (smartcards, badges, other cards, etc.) usage with smartcard readers are well known in the art. Additionally, it is well known that both “contact” and “contactless” readers are widely used and available in the art. Since these operations are so widespread, there are frequent occasions when badge-wearing and smartcard-wearing persons must suffer inconveniences and time delays associated with personal identity verification: queuing delays (waiting in line to access a badge reader); stop-and-go driving delays (e.g., at security gates); etc.

Notwithstanding, there appears to be no apparatus in the art capable of holding the badge or smartcard; reading from or writing to the badge while holding it; and securely and wirelessly communicating smartcard data plus successful biometric fingerprint authentication result data to an application via an external RF transceiver.

### OBJECTS OF THE INVENTION

Accordingly, it is one primary object of the present invention, to provide a cardholding apparatus capable of interactively, wirelessly, and securely exchanging data between the apparatus and an application, via an external RF transceiver.

It is another primary object, to provide a cardholding apparatus capable of visually displaying a card or badge inserted therein. It is a related object to provide a clip-on “badgeholder-style” product in preferred embodiments, which are affixed onto (e.g.) a user's external clothing (or elsewhere) to present a card or badge for easy inspection.

It is a further primary object, to provide a reliable onboard biometric fingerprint authentication subsystem for the cardholding apparatus which is capable of authenticating one or more fingerprints of a prospective user, prior to allowing the user to use the apparatus to transmit smartcard data to an application, via an external RF transceiver.

It is another primary object, to provide a cardholding apparatus capable of reading, extracting, and transmitting card data to the user's selected application—but only after an enrolled user authenticates themselves using the onboard biometric fingerprint authentication subsystem prior to reading, extracting and transmitting the card data to an external wireless smartcard reader.

It is yet another primary object of the invention, to provide an optional cryptographic subsystem which can be embedded within the cardholding apparatus and coupled to a processor and a wireless communication subsystem, which is capable of encrypting and decrypting data to be exchanged between the apparatus and the user's selected application, via a wireless external RF transceiver.

### SUMMARY OF THE INVENTION

The smartcard holding and receiving apparatus of the present invention is a compact, convenient badge designed with open system architecture to meet international communications, interface, and security standards. The apparatus extends the capabilities of existing ID card technology—such as “PIV” card (Personal Identity Verification); the “CAC” (Common Access Card), the “TWIC” (Transportation Workers Identification Card); etc.—to include portable biometric fingerprint authentication, plus improved wireless security and range.

For some applications, the wireless card reader can be used (“hardwired”) with a separate Mini-USB to USB cable. This is particularly useful for applications where system administrators and application owners have high security requirements.

Alternatively, the extended-range radio-frequency link is performed to the standard IEEE 802.15.4 PAN specifications.

One primary embodiment of the present invention is cryptographically secured by employing either conventional (and/or “customized”) encryption techniques. Exemplars of these techniques include (e.g.) the federally-approved (FIPS) 197 (AES-256), and also include strong cryptographic challenge-response authentication protocols, e.g., those following the methods of ISO/IEC 9798-2. This added application level cryptographic security brings the cryptographic protection in the cardholding apparatus up to high strength by protecting against attacks such as the “man-in-the-middle”, “replay”, “key exploitation”, and “algorithm” attacks.

Additionally, radio functions of the cardholding apparatus are not enabled until after a prospective user successfully authenticates his/her self to the onboard biometric fingerprint sensor and further authenticates to the badge, preventing misuse of the cardholding apparatus by eavesdroppers as a surreptitious tracking device.

The present invention can be a part of a complete system, including (e.g.) an optional physical access controlling device such as a “gatehouse receiver” (e.g., a security transceiver at a gate guard station).

The present invention expedites the reading of smartcards, plus better secures smartcards (or other adaptable types of cards, etc.). The cardholding apparatus reads the data contained in a smartcard inserted therein, but the apparatus does not transmit the data until after a user's biometric fingerprint (identity) authentication is complete. This inhibition feature can better secure contactless smartcards and their data, insofar as the apparatus will transmit not transmit smartcard data to an application via an external RF transceiver unless the biometric fingerprint authentication is successfully completed. The secure exchange of data can be further protected, using standard cryptographic techniques.

The invention enables (e.g.) credit cards and identification cards or badges designed for improving secure use of—and communication with—target applications, to also be used securely with wireless readers. This can enable users to access physical and/or logical and/or financial resources (and/or any other protected assets.

One typical preferred embodiment of the cardholding apparatus is constructed of clear plastic and/or is of sufficiently open design that it displays visible credentials that are printed on both sides of a smartcard, a badge, or other card. In addition to (1) holding a smartcard with “either side visible” for convenient visual inspection, this preferred embodiment is also capable of: (2) actively reading identification data from the smartcard, (3) actively reading successful enrolled user authentication data (e.g., after biometric fingerprint authentication), (4) cryptographically protect the data, and (5) transmit the necessary data—via radio or other wireless communications device (e.g., via an external RF transceiver)—to the user's selected application or other “data sink”.

The apparatus of the invention includes a biometric authenticator such as a fingerprint sensor and authenticator (as shown in figures appended hereto) in order to positively and biometrically identify a prospective user—equipping and allowing the cardholding apparatus to block, inhibit, or withhold data transmission and/or reception until the enrolled and authorized user authenticates themselves. This helps prevent the use of the device for unauthorized tracking or wireless data access.

In operation, an authorized user enrolled into a smartcard and/or badge: (1) inserts their card into a card insertion slot (i.e., an opening) on the enclosure of the smartcard holding apparatus; (2) the cardholding apparatus prompts the user to biometrically authenticate themselves via the onboard biometric fingerprint sensor prior to reading and accessing the data on the inserted smartcard; (3) the user responds to the prompt, by successfully authenticating themselves; (5) after the user successfully authenticates themselves, (a) the “data result” of a successful user authentication is generated—e.g., a “successful authentication completed” result signal—then (b) the data from the inserted card can be read by the onboard smartcard reader subsystem. One or both of (a) and (b) are optionally encrypted by a cryptographic subsystem onboard the cardholding apparatus, and are then (6) wirelessly transmitted to the user's selected application, by means of the external RF transceiver; (7) the application (and/or the RF transceiver, depending on configuration and implementation details) receives, decrypts, and verifies the transmission; and (8) the application and/or the external RF transceiver transmits an acknowledgment back to the cardholding apparatus.

The cardholding apparatus is attachable (e.g.) to the cardholder's clothing and holds and displays the smartcard's or badge's visible credentials for convenient visual inspection, while actively reading identification data from the badge, cryptographically protecting the data, and transmits that data (once allowed to access the data) by means of radio or other wireless communications to an application.

This invention enables identification cards or badges that are designed for secure use with contact readers to be used with contactless readers to enable physical or logical access to protected assets.

In one embodiment, the card holding device contains a layer of radio-frequency shielding material that is capable of blocking RF signals from the outside from reaching the card and vice versa. This protects cards that have a contactless (wireless) feature but lack tracking protection from being remotely read and tracked. The cardholding device, however, can interrogate contactless cards within this shielded space and can retransmit the card data to and from an external remote wireless reader, applying cryptographic security and optional biometric authentication. This has the effect of converting a less secure contactless card into a protected component of a secured wireless system which has potentially increased range and enhanced security.

Note that the wireless feature of the present invention protects against tracking and surreptitious remote reading by requiring up to three conditions to be met before the device will transmit. They are: pressing the fingerprint sensor, authenticating the cardholder's fingerprint, and optionally recognizing the transmitted code of an authorized transceiver system. Thus (depending on application and security details) the cardholding device transmits only after the authorized cardholder has been biometrically authenticated; otherwise, the Wireless Biometric Card Reader is electronically silent.

In a separate embodiment, the cardholder can be adapted to read the magnetic swipe of a card and upon authentication, hold the data for secure transmission to a wireless reader.

### DETAILED DESCRIPTION OF THE INVENTION

### Brief Description of Figures

FIG. 1 shows the Wireless Biometric Cardholding Apparatus

FIG. 2 shows a typical Smartcard (e.g., CAC, TWIC, or PIV type card)

FIG. 3 shows the Cardholding Apparatus with a Smartcard inserted

FIG. 4 shows a Block Diagram of the System

FIG. 5 shows “Authenticating a fingerprint to Check a User Identity”

### Reference Numbers

100 Wireless biometric smartcard reader

102 Biometric sensor and processor module

104 Red LED

106 Green LED

108 Opening for sound generator

110 Smartcard

112 Smartcard chip

114 Printed ID information on smartcard

116 RF Transceiver on the apparatus

118 RF Transceiver on the application system

120 Application system

122 Smartcard reader within the apparatus

124 Processor(s) for authentication and cryptographic processing

126 User's finger to be authenticated

### DISCUSSION

This invention enables credit cards, identification cards or badges that have been designed for secure use with contact readers to also be used securely with wireless readers to enable physical or logical access to protected assets and applications governing the access to and usage of these protected assets.

In addition to holding a smartcard for convenient visual inspection, this invention is also capable of actively reading the embedded card data from the smartcard, cryptographically protecting the data, and transmitting it by means of radio or other wireless communications to a reader terminal. Usage of the biometric authenticator positively identifies the cardholder and inhibits transmission until the badgeholder authorizes identification in order to prevent the use of the device for unauthorized reading, unauthorized tracking or unauthorized wireless data access.

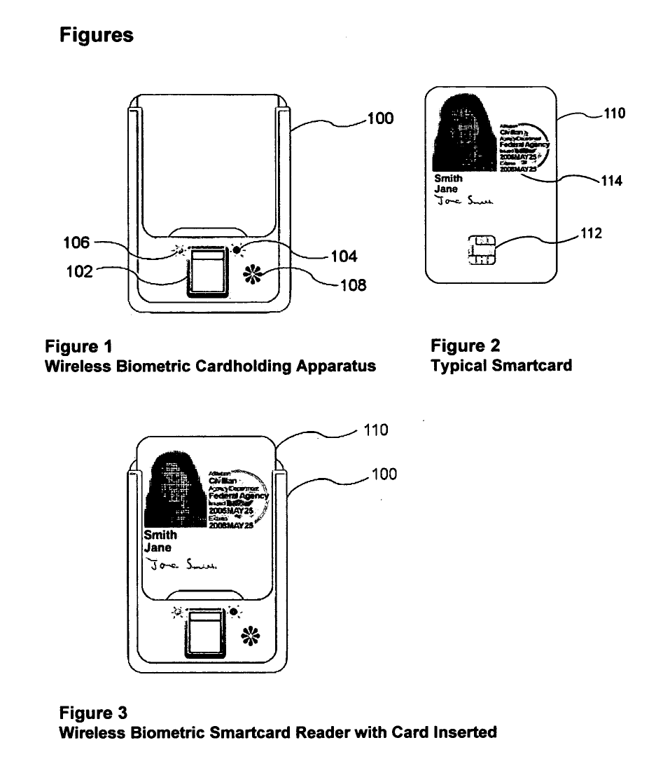

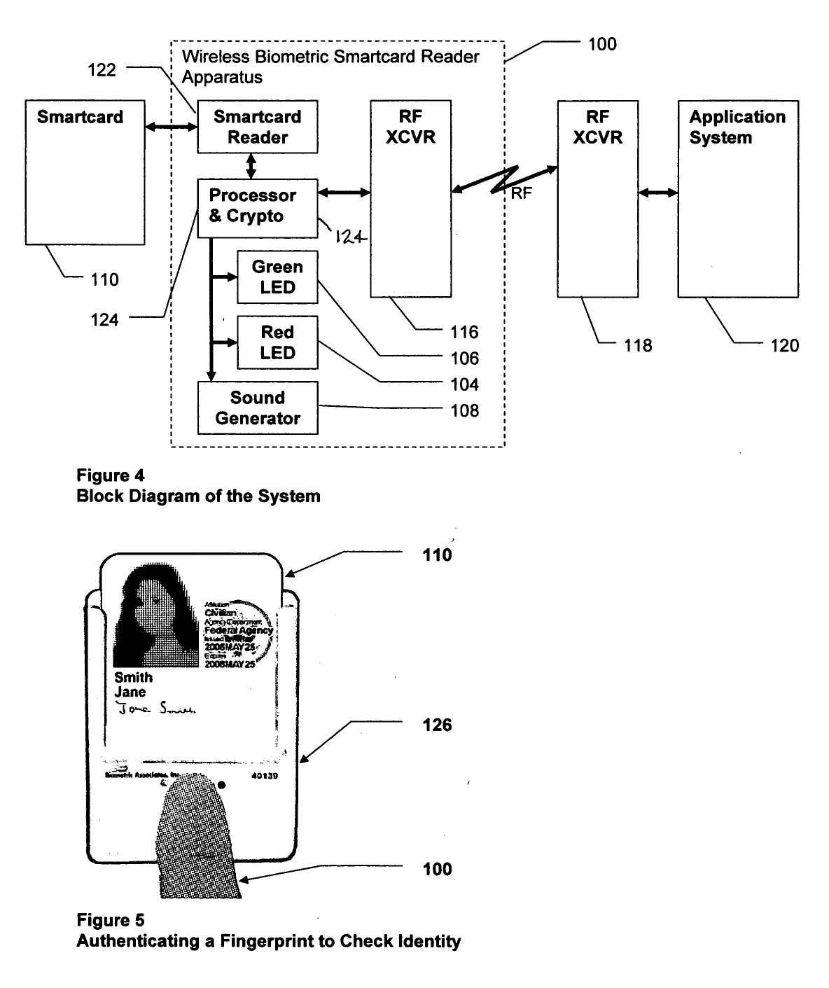

FIG. 1 shows the Wireless Biometric Smartcard Reader apparatus 100 in the form of the cardholding apparatus of the present invention, showing an insertion slot in the topmost part of the card, which enables the insertion of a smartcard 110 (of FIG. 2) which has in this case optional printed identifying data 114. When fully inserted as shown in FIG. 3, the smartcard contacts 112 mate with smartcard reader contacts (not shown) behind fingerprint sensor 102 so that the processor 124 (seen in FIG. 4) mounted with the fingerprint sensor in module 102 can read or write the card.

The smartcard 110 can be a standard smartcard such as the Federal Employee/Contractor Personal Identity Verification (PIV) card, the DOD Common Access Card (CAC) or the Transportation Worker's Identity Card (TWIC), for example.

Again referring to FIG. 1, the fingerprint sensor 102 is an electronic fingerprint scanner of the swipe or area type (well known in the art) and is also coupled to the processor. The Green LED 106 is lit by the processor to indicate successful matching between a fingerprint obtained from the biometric fingerprint authentication scanner and a reference fingerprint or reference fingerprint template that has been stored in the memory of the processor or obtained from the memory of card. In this case, radio transmission to an authorized transceiver system will be enabled. In contrast, the red LED 104 can be lit to demonstrate that fingerprint authentication was unsuccessful, in which case transmission will not be enabled.

Also connected to the processor is a sound generator 108, e.g., a buzzer or speaker, to alert a user to the status of fingerprint authentication or wireless communication, if the user or wearer is unable to see the LEDs as may happen, e.g., when driving a vehicle.

FIG. 4 is a block diagram of the system showing smartcard 110 connected by contacts (or proximity loop or magnetic swipe) to the smartcard reader 122 that is contained within the elements of the apparatus 100 of the present invention. Smartcard reader 122 is interfaced to processor 124 which coordinates the operation of the apparatus and also performs the cryptographic protection functions, when employed, on the data transmitted from the RF Transceiver 116 within the apparatus. Processor 124 also sets the green LED 106 and red LED 104 to indicate successful or unsuccessful biometric authentication, successful card use, and/or successful communication with the remote RF transceiver 118 that is connected to the application system 120. The application system may be a gatehouse vehicle access system, a door access control, a computer access system, a financial credit transaction system or other standard smartcard application.

There are several independent options for storing the fingerprint biometric reference data and performing the fingerprint matching operation depending upon the existing smartcard type used, the security policy of the user and other considerations. As is known to practitioners of the art, the fingerprint matching algorithm may reside in the card 110 (match-on-card), on the apparatus 100 of the present invention (match-on-reader), or in the application system 120 (match-in-application). The fingerprint reference image or template may be stored in the smartcard 110 as in the Federal PIV card (standard NIST PUB 201), may be stored on the processor memory 124 of the apparatus 100, or may be stored in a storage location or database available to the application as in the DOD CAC card. The present invention can be made to implement any of these combinations.

Additionally, it must be noted there is one claim reference and two mentions of a “clip” device which can be permanently or temporarily affixed to the back of the cardholding apparatus of the present invention. This permits “clip-on” capability, e.g., attachment of the apparatus onto a user's external clothing to conveniently present the cardholding device plus an inserted smartcard or badge for easy visual inspection. There are no illustrations shown of this clip. Combining the clip, with the apparatus gives additional utility to the present invention, because the invention can be used interchangeably or as a replacement for existing clip-on badges and cards known in the art and used widely today.

Although the present invention is described in detail for a few configurations and implementations, and as discussed and illustrated herein, it should be obvious to one skilled in the art, that many variations, combinations, and alternative configurations and implementations are possible. For example, when a singular user is mentioned as needed to authenticate, multiple different users may be authorized and enrolled to use the same cardholding apparatus, either at different times or at the same time (e.g., for very high security applications when more than one user may need to be authenticated).

Accordingly, the pervasiveness and scope of this patent application is not limited only by embodiments described and claimed herein.

I claim:

1. A cardholding apparatus adapted for wireless exchange of data between a smartcard and an application via an external RF transceiver, comprising:
a smartcard enclosure having an insertion slot for inserting said smartcard therewithin;
at least one processor;
an authentication subsystem adapted for biometric fingerprint authentication of a user;
a smartcard reader subsystem coupled to said insertion slot and adapted for reading data from said smartcard;
a wireless communications subsystem for exchanging data between said smartcard and said application via said external RF transceiver;
and
a power subsystem.

2. The apparatus of claim 1, wherein said biometric fingerprint authentication occurs prior to said wireless exchange of data, and wherein said successful biometric fingerprint authentication of said user enables said cardholding apparatus to access data disposed within said smartcard.

3. The apparatus of claim 1, wherein biometric fingerprint matching processing occurs on at least one of said cardholding apparatus and said smartcard and a host system.

4. The apparatus of claim 1, wherein said cardholding apparatus is further adapted to transmit a successful authentication completed signal to said application via said external RF transceiver to signify that at least one fingerprint of said user has been successfully authenticated by said authentication subsystem.

5. The apparatus of claim 1, wherein said smartcard enclosure further comprises transparent material to permit an inserted smartcard to be visually inspected without requiring removal from said enclosure.

6. The apparatus of claim 1, wherein fingerprint templates reside on at least one of said smartcard and said cardholding apparatus and a host system.

7. The apparatus of claim 1, wherein said smartcard insertion slot holds said smartcard by the bottommost part of said smartcard in order to sufficiently expose and present the topmost part of said smartcard for visual inspection.

8. The apparatus of claim 1, wherein said smartcard enclosure is comprised of material opaque to electromagnetic waves in order to block unauthorized wireless access to proximity card functions on said smartcard.

9. The apparatus of claim 1, further comprising a cryptographic subsystem.

10. The apparatus of claim 9, wherein said cryptographic subsystem is coupled to said wireless communications subsystem.

11. The apparatus of claim 9, wherein said cryptographic subsystem is adapted for encrypting data disposed upon said smartcard.

12. The apparatus of claim 9, wherein said cryptographic subsystem: (1) is adapted to encrypt data transmitted from said apparatus to said application via said external RF transceiver prior to transmission thereof, (2) is adapted to decrypt data received from said external RF transceiver, and (3) is further adapted for authenticating both encrypted and decrypted data.

13. A method of using a cardholding apparatus for wireless exchange of data between a smartcard and an application via an external RF transceiver, the steps comprising:
enrolling an authorized user into said cardholding apparatus;
issuing said cardholding apparatus for use by said authorized user;
inserting said smartcard into a smartcard insertion slot disposed upon said cardholding apparatus;
authenticating said authorized user with a biometric fingerprint authentication subsystem disposed upon said cardholding apparatus;
at least one of reading data from said smartcard and writing data to said smartcard, after said user has successfully completed biometric fingerprint authentication;
and
communicating via external RF transceivers said smartcard data to and from said application.

14. The method of claim 13, wherein said method additionally comprises the cryptographic data protection steps of: (1) encrypting data disposed upon said smartcard, and (2) encrypting said data prior to transmission of said data to said application via said external RF transceiver, and (3) decrypting data received from said wireless smartcard reader when said received data is encrypted.

15. A system for secure and wireless exchange of data between a smartcard, a cardholding apparatus, and a user-selected application, via an external RF transceiver, said system comprising:
at least one authorized user;
said smartcard operated by an enrolled and authorized user;
said cardholding apparatus having a biometric fingerprint authentication subsystem;
said application;
and
said external RF transceiver.

16. The system of claim 15, further comprising a cryptographic subsystem for at least one of: (1) encrypting data disposed within said smartcard; (2) encrypting data extracted from said smartcard prior to transmission thereof; (3) decrypting data received from said wireless external RF transceiver after reception thereof; and (4) authenticating both encrypted and decrypted data in accordance with security policies.

17. The system of claim 15, where said at least one authorized user fingerprint is enrolled in at least one of said smartcard, said cardholding apparatus, and a host system.

18. The apparatus of claim 1, further comprising a clip means for fastening said apparatus onto said user so said apparatus is suitable for use as an identification badgeholder.
